(19) United States
(12) Patent Application Publication
(10) Pub. No.: US 2021/0317263 A1
(43) Pub. Date: Oct. 14, 2021

(54) MINERAL-FILLED POLYCARBONATE-POLYALKYLENE TEREPHTHALATE COMPOSITION, MOULDING COMPOUND AND MOULDED BODIES WITH GOOD IMPACT TOUGHNESS

(71) Applicant: Covestro Intellectual Property GmbH & Co. KG, Leverkusen (DE)

(72) Inventors: Ralf Hufen, Duisburg (DE); Achim Feldermann, Düsseldorf (DE); Marius Nolte, Köln (DE)

(21) Appl. No.: 17/264,952

(22) PCT Filed: Aug. 6, 2019
(86) PCT No.: PCT/EP2019/071125

§ 371 Date: Feb. 1, 2021

(30) Foreign Application Priority Data
Aug. 9, 2018 (EP) 18188187.1

(51) Int. Cl. C08G 64/04; C08G 63/183; C08K 3/34; C08K 3/32; C08K 3/04; C08K 5/09; C08K 5/11; B29C 48/00; B29C 49/00; B29C 51/00

(52) U.S. Cl. CPC C08G 64/04; C08G 63/183; C08K 3/34; C08K 3/32; C08K 3/04; B29K 2067/003; C08K 5/11; B29C 48/022; B29C 49/0005; B29C 51/002; C08K 5/09

(57) ABSTRACT

The invention relates to a composition for producing a thermoplastic moulding compound, wherein the composition contains the following constituents or consists of same: A) between 50 and 70 wt. % of at least one aromatic polycarbonate, B) between 16 and 40 wt. % of at least one polyalkylene terephthalate, C) between 8 and 22 wt. % of at least one mineral filler based on talc, D) between 0.0110 and 0.0280 wt. % of phosphorous acid, and E) between 0 and 8.0 wt. % of at least one additive. Furthermore, the invention relates to a method for producing a thermoplastic moulding compound from the composition, to the moulding compound itself, and to the use of the composition and the moulding compound for producing moulding bodies.

The present invention relates to a mineral-filled composition based on polycarbonate and polyalkylene terephthalate for producing a thermoplastic molding compound, to the molding compound itself, to the use of the composition or molding compound for producing molded articles and to the molded articles themselves.

The molded articles are preferably used in automaking, more preferably as an exterior component.

Filler-containing polycarbonate molding compounds (PC molding compounds) containing semicrystalline polyesters and mineral fillers are known.

EP 1 992 663 A1 discloses polycarbonate compositions containing a further thermoplastic and talc. Polyesters are also disclosed as further thermoplastics. The compositions are characterized by simple production in an extrusion process, stiffness, flame retardancy, toughness and thermal stability.

U.S. Pat. No. 5,637,643 discloses compositions containing polycarbonate, polyester and surface-modified talc and also a phosphite-based antioxidant. The compositions feature good mechanical properties and good thermal stability.

JP 1995-101623 discloses compositions containing polycarbonates, polyesters, acrylate rubber and talc and also an antioxidant. The compositions are suitable for the production of vehicle parts and feature high rigidity and good surface smoothness.

JP 1994-097985 discloses compositions containing polycarbonate, talc, aromatic polyesters and organic phosphate esters. The compositions have a high stiffness, good surface properties and high toughness and are suitable for producing molded articles having high thermal stability and mechanical strength.

DE-A 19 753 541 discloses polycarbonate molding compounds containing semiaromatic polyesters, graft copolymers and mineral fillers which exhibit a sufficient toughness for vehicle body exterior parts. However, the claimed molding compounds show inadequate heat resistances.

EP-A 135 904 describes polycarbonate molding compounds containing polyethylene terephthalate, polybutadiene-based graft copolymers and talc in an amount of up to 4% by weight. The disclosed advantage is an advantageous characteristics combination of low warpage and good toughness.

JP-A 08 176 339 describes polycarbonate molding compounds containing talc as mineral filler. ABS resins, polyethylene terephthalate and polybutylene terephthalate may be employed as further blend partners. The molding compounds are said to have the advantage of good impact strength and surface quality.

JP-A 07 025 241 describes polycarbonate molding compounds having a high stiffness and good surface quality. The molding compounds contain 60% to 70% by weight of polycarbonate, 20% to 30% by weight of polyester, 5% to 10% by weight of acrylate rubber and 5% to 10% by weight of talc and also 0.1 to 1 part by weight (based on 100 parts of polymer components) of antioxidant.

WO 85/02622 discloses polycarbonate-polyester compositions stabilized against yellowing with phosphorus-based acids.

DE2414849 A1 discloses mixtures of polyester resin and polycarbonate resin protected against discoloration with phosphorus compounds.

EP0417421 A1 discloses esters of phosphorous acid as stabilizers for polycarbonate-polyalkylene terephthalate compositions.

Vehicle body exterior parts made of plastics must generally be painted. The applied paint layers must generally be baked and cured at elevated temperature. The temperature and duration required therefor are dependent on the paint systems used. The plastic material of the vehicle body accessory parts must ideally show no changes, such as for example irreversible deformations, during the curing/baking procedure. It is therefore necessary to provide thermoplastic polycarbonate molding compounds having a high heat resistance.

In such applications it is often additionally necessary to achieve a high stiffness in conjunction with a low coefficient of thermal expansion (CLTE), i.e. a high dimensional stability.

Further demands placed on vehicle body accessory parts made of plastics are good toughness when subjected to impacts, especially also at low temperatures.

The molding compounds used for producing the vehicle body exterior parts must additionally show good flowability in the melt.

During production of the polycarbonate-polyester molding compounds during melt compounding and/or during processing of the molding compounds, for example during injection molding, undesired transesterification reactions between the polycarbonate and the polyester often occur. Such reactions occur particularly under unfavorable conditions such as high temperatures, long residence times and under high mechanical stresses during melt compounding or during injection molding.

This can result in impairment of important properties. Heat resistance or toughness of the molded articles may be reduced for instance. In addition, morphological properties may be altered, i.e. the crystallization behavior of the polyester disrupted and the glass transition temperatures of the components polycarbonate and polyester shifted to lower values. It is therefore desirable to largely inhibit the transesterification reactions.

It was therefore desirable to provide a composition for producing a thermoplastic molding compound which makes it possible to meet the described requirements.

It was especially desirable to provide a composition for producing a thermoplastic molding compound where the molding compound has a good melt flowability and is suitable for producing molded articles having improved impact strength and good heat resistance.

Transesterification reactions between polycarbonate and polyester shall moreover preferably be reduced, thus retaining heat resistance and morphology even under unfavorable production and processing conditions.

It has now been found that, surprisingly, the advantageous properties are exhibited by a composition for producing a thermoplastic molding compound, wherein the composition contains or consists of the following constituents:

A) 50% to 70% by weight, preferably 52% to 68% by weight, more preferably 54% to 66% by weight, of at least one aromatic polycarbonate,

B) 16% to 40% by weight, preferably 18% to 30% by weight, particularly preferably 20% to 26% by weight, of at least one polyalkylene terephthalate,

C) 8% to 22% by weight, preferably 10% to 20% by weight, particularly preferably 12% to 18% by weight, of at least one talc-based mineral filler,

D) 0.0110% to 0.0280% by weight, preferably 0.0115% to 0.0250% by weight, particularly preferably 0.0120% to 0.0220% by weight, of phosphorous acid

E) 0% to 8.0% by weight, preferably 0.1% to 7% by weight, particularly preferably 0.3% to 6% by weight, of at least one additive.

In a preferred embodiment the composition consists of the components A to E to an extent of 90% by weight, more preferably to an extent of 95% by weight and particularly preferably to an extent of 100% by weight.

In a preferred embodiment the composition is free from rubber-modified graft polymers.

In a preferred embodiment the composition is free from vinyl (co)polymers, in particular SAN (styrene-acrylonitrile).

In a preferred embodiment the composition is free from phosphorus-based flame retardants.

In a preferred embodiment the composition is free from carbon fibers.

Free from a component is to be understood as meaning that less than 0.5% by weight, preferably less than 0.1% by weight, especially preferably 0% by weight, of this component is present in the composition.

The weight ratio of component D to component B is preferably 0.0003:1 to 0.0010:1 and particularly preferably 0.0004:1 to 0.0008:1. This results in a particularly advantageous combination of good mechanical properties and effective inhibition of the transesterification reactions described above.

In a further preferred embodiment the proportion of the component D is 0.0120% to 0.0160% by weight.

The individual abovementioned preferential ranges of different components and the preferred embodiments may be freely combined with one another.

Component A

Aromatic polycarbonates and/or aromatic polyestercarbonates of component A which are suitable in accordance with the invention are known from the literature or producible by processes known from the literature (for production of aromatic polycarbonates see, for example, Schnell, “Chemistry and Physics of Polycarbonates”, Interscience Publishers, 1964, and also DE-AS 1 495 626, DE-A 2 232 877, DE-A 2 703 376, DE-A 2 714 544, DE-A 3 000 610, DE-A 3 832 396; for production of aromatic polyestercarbonates, for example DE-A 3 007 934).

Aromatic polycarbonates are produced for example by reaction of diphenols with carbonyl halides, preferably phosgene and/or with aromatic dicarbonyl dihalides, preferably dihalides of benzenedicarboxylic acid, by the interfacial process, optionally using chain terminators, for example monophenols, and optionally using trifunctional or more than trifunctional branching agents, for example triphenols or tetraphenols. Production via a melt polymerization process by reaction of diphenols with for example diphenyl carbonate is likewise possible.

Diphenols for the production of the aromatic polycarbonates and/or aromatic polyestercarbonates are preferably those of formula (I)

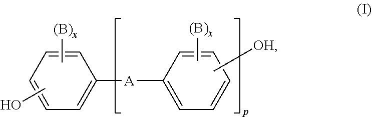

wherein

A is a single bond, C₁ to C₅-alkylene, C₂ to C₅-alkylidene, C₅ to C₆-cycloalkylidene, —O—, —SO—, —CO—, —S—, —SO₂—, C₆ to C₁₂-arylene, onto which further aromatic rings optionally containing heteroatoms may be fused,
or a radical of formula (II) or (III)

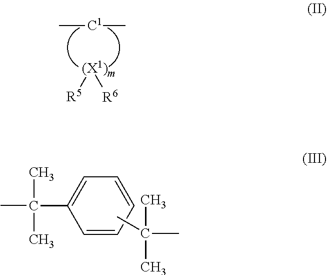

B is in each case C₁ to C₁₂-alkyl, preferably methyl, halogen, preferably chlorine and/or bromine,

x is independently at each occurrence 0, 1 or 2,

p is 1 or 0, and

R⁵ and R⁶ are individually choosable for each X¹ and are independently of one another hydrogen or C₁ to C₆-alkyl, preferably hydrogen, methyl or ethyl,

X1 is carbon and

m is an integer from 4 to 7, preferably 4 or 5, with the proviso that on at least one atom X¹, R⁵ and R⁶ are simultaneously alkyl.

Preferred diphenols are hydroquinone, resorcinol, dihydroxydiphenols, bis(hydroxyphenyl)-C₁-C₅-alkanes, bis(hydroxyphenyl)-C₅-C₆-cycloalkanes, bis(hydroxyphenyl) ethers, bis(hydroxyphenyl) sulfoxides, bis(hydroxyphenyl) ketones, bis(hydroxyphenyl) sulfones and α,α-bis(hydroxyphenyl)diisopropylbenzenes and also ring-brominated and/or ring-chlorinated derivatives thereof.

Particularly preferred diphenols are 4,4′-dihydroxybiphenyl, bisphenol A, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxybiphenyl sulfide, 4,4′-dihydroxybiphenyl sulfone, and also the di- and tetrabrominated or chlorinated derivatives of these, for example 2,2-bis(3-chloro-4-hydroxyphenyl)propane, 2,2-bis(3,5-dichloro-4-hydroxyphenyl)propane or 2,2-bis(3,5-dibromo-4-hydroxyphenyl)propane. 2,2-Bis(4-hydroxyphenyl)propane (bisphenol A) is especially preferred.

The diphenols may be used individually or in the form of any desired mixtures. The diphenols are known from the literature or obtainable by processes known from the literature.

Examples of chain terminators suitable for the production of the thermoplastic aromatic polycarbonates include phenol, p-chlorophenol, p-tert-butylphenol or 2,4,6-tribromophenol, and also long-chain alkylphenols such as 4-[2-(2,4,4-trimethylpentyl)]phenol, 4-(1,3-tetramethylbutyl)phenol according to DE-A 2 842 005 and monoalkylphenol or dialkylphenols having a total of from 8 to 20 carbon atoms in the alkyl substituents, for example 3,5-di-tert-butylphenol, p-isooctylphenol, p-tert-octylphenol, p-dodecylphenol and 2-(3,5-dimethylheptyl)phenol and 4-(3,5-dimethylheptyl)phenol. The amount of chain terminators to be used is generally between 0.5 mol % and 10 mol % based on the molar sum of the diphenols used in each case.

The thermoplastic aromatic polycarbonates have average molecular weights (weight-average M_{w}, measured by GPC (gel permeation chromatography) using a polycarbonate standard based on bisphenol A) of 20 to 40 kg/mol, preferably 20 to 32 kg/mol, particularly preferably 22 to 28 kg/mol.

The preferred ranges achieve a particularly advantageous balance of mechanical and rheological properties in the compositions according to the invention.

The thermoplastic aromatic polycarbonates may be branched in a known manner, and preferably through incorporation of 0.05 to 2.0 mol % based on the sum of the diphenols used of trifunctional or more than trifunctional compounds, for example those having three or more phenolic groups. It is preferable to employ linear polycarbonates, more preferably based on bisphenol A.

Both homopolycarbonates and copolycarbonates are suitable. It is also possible to employ 1% to 25% by weight, preferably 2.5% to 25% by weight, based on the total amount of diphenols to be used, of polydiorganosiloxanes having hydroxyaryloxy end groups for producing copolycarbonates of component A according to the invention. These are known (U.S. Pat. No. 3,419,634) and may be produced by processes known from the literature. Likewise suitable are polydiorganosiloxane-containing copolycarbonates; the production of the polydiorganosiloxane-containing copolycarbonates is described in DE-A 3 334 782 for example.

Aromatic dicarbonyl dihalides for production of aromatic polyester carbonates are preferably the diacyl dichlorides of isophthalic acid, of terephthalic acid, of diphenyl ether 4,4′-dicarboxylic acid and of naphthalene-2,6-dicarboxylic acid.

Particular preference is given to mixtures of the diacyl dichlorides of isophthalic acid and of terephthalic acid in a ratio between 1:20 and 20:1.

Production of polyester carbonates additionally makes concomitant use of a carbonyl halide, preferably phosgene, as the bifunctional acid derivative.

Chain terminators contemplated for the production of the aromatic polyester carbonates are not only the abovementioned monophenols but also the chlorocarbonic esters of these, and also the acyl chlorides of aromatic monocarboxylic acids, which can optionally have substitution by C₁ to C₂₂-alkyl groups or by halogen atoms; aliphatic C₂ to C₂₂-monocarbonyl chlorides can also be used as chain terminators here.

The amount of chain terminators in each case is 0.1 to 10 mol %, based on moles of diphenol in the case of the phenolic chain terminators and on moles of dicarbonyl dichloride in the case of monocarbonyl chloride chain terminators.

One or more aromatic hydroxycarboxylic acids may also be used in the production of aromatic polyestercarbonates.

The aromatic polyestercarbonates may be linear or branched in a known manner (see DE-A 2 940 024 and DE-A 3 007 934), wherein linear polyestercarbonates are preferred.

Branching agents that may be used are for example tri- or polyfunctional carbonyl chlorides, such as trimesoyl trichloride, cyanuroyl trichloride, 3,3′,4,4′-benzophenonetetracarbonyl tetrachloride, 1,4,5,8-naphthalenetetracarbonyl tetrachloride or pyromellitoyl tetrachloride, in amounts of 0.01 to 1.0 mol % (based on dicarbonyl dichlorides employed) or tri- or polyfunctional phenols, such as phloroglucinol, 4,6-dimethyl-2,4,6-tri(4-hydroxyphenyl)hept-2-ene, 4,6-dimethyl-2,4,6-tri(4-hydroxyphenyl)heptane, 1,3,5-tri(4-hydroxyphenyl)benzene, 1,1,1-tri(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol, tetra(4-hydroxyphenyl)methane, 2,6-bis(2-hydroxy-5-methylbenzyl)-4-methylphenol, 2-(4-hydroxyphenyl)-2-(2,4-dihydroxyphenyl)propane, tetra(4-[4-hydroxyphenylisopropyl]phenoxy)methane, 1,4-bis[4,4′-dihydroxytriphenyl)methyl]benzene, in amounts of 0.01 to 1.0 mol % based on diphenols employed. Phenolic branching agents may be initially charged together with the diphenols; acid chloride branching agents may be introduced together with the acid dichlorides.

The proportion of carbonate structural units in the thermoplastic aromatic polyestercarbonates may be varied as desired. The proportion of carbonate groups is preferably up to 100 mol %, in particular up to 80 mol %, particularly preferably up to 50 mol %, based on the sum of ester groups and carbonate groups. Both the ester fraction and the carbonate fraction of the aromatic polyestercarbonates may be present in the form of blocks or in random distribution in the polycondensate.

The thermoplastic aromatic polycarbonates and polyestercarbonates may be used alone or in any desired mixture.

It is preferable to employ polycarbonate based on bisphenol A as component A.

Component B

According to the invention a polyalkylene terephthalate or a mixture of polyalkylene terephthalates is employed as component B.

In a preferred embodiment they are reaction products of terephthalic acid or reactive derivatives thereof, such as dimethyl esters or anhydrides, and aliphatic, cycloaliphatic or araliphatic diols and also mixtures of these reaction products.

The polyalkylene terephthalates thus contain structural units derived from terephthalic acid and aliphatic, cycloaliphatic or araliphatic diols.

In the context of the present invention polyalkylene terephthalates is to be understood as also including polyesters which contain not only terephthalic acid radicals but also proportions of further aromatic, aliphatic or cycloaliphatic dicarboxylic acids in an amount of up to 50 mol %, preferably up to 25 mol %. These may contain for example aromatic or cycloaliphatic dicarboxylic acids having 8 to 14 carbon atoms or aliphatic dicarboxylic acids having 4 to 12 carbon atoms, for example phthalic acid, isophthalic acid, naphthalene-2,6-dicarboxylic acid, 4,4′-biphenyldicarboxylic acid, succinic acid, adipic acid and cyclohexanedicarboxylic acid.

It is preferable to employ only terephthalic acid and isophthalic acid.

Diols employed in the production of the polyalkylene terephthalates according to the invention include for example ethylene glycol, butane-1,4-diol, propane-1,3-diol, tetramethylcyclobutanediol, isosorbitol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di($-hydroxyethoxy)benzene, 2,2-bis(4-hydroxycyclohexyl)propane, 2,4-dihydroxy-1,1,3,3-tetramethylcyclobutane, 2,2-bis(4-$-hydroxyethoxyphenyl)propane and 2,2-bis(4-hydroxypropoxyphenyl)propane and mixtures thereof (DE-A 2 407 674, 2 407 776, 2 715 932).

Common names of these polyalkylene terephthalates are for example PET, PBT, PETG, PCTG, PEICT, PCT or PTT.

Preferred polyalkylene terephthalates contain at least 80% by weight, preferably at least 90% by weight, based on the dicarboxylic acid component of terephthalic acid radicals and at least 80% by weight, preferably at least 90% by weight, based on the diol component of ethylene glycol and/or butane-1,4-diol radicals.

In a preferred embodiment polyalkylene terephthalates produced solely from terephthalic acid and the reactive derivatives thereof (for example the dialkyl esters thereof) and ethylene glycol and/or butane-1,4-diol and mixtures of these polyalkylene terephthalates are employed as component B.

In a particularly preferred embodiment polyethylene terephthalate is employed as component B.

The polyalkylene terephthalates may be branched through incorporation of relatively small amounts of tri- or tetrahydric alcohols or tri- or tetrabasic carboxylic acids, for example according to DE-A 1 900 270 and US B 3 692 744. Examples of preferred branching agents are trimesic acid, trimellitic acid, trimethylolethane and trimethylolpropane, and pentaerythritol.

Particular preference is given to polyalkylene terephthalates which have been produced solely from terephthalic acid and the reactive derivatives thereof (e.g. the dialkyl esters thereof) and ethylene glycol and/or butane-1,4-diol, and to mixtures of these polyalkylene terephthalates.

The preferably employed polyalkylene terephthalates preferably have an intrinsic viscosity of 0.52 dl/g to 0.95 dl/g, particularly preferably 0.56 dl/g to 0.80 dl/g, very particularly preferably 0.58 dl/g to 0.68 dl/g. To determine intrinsic viscosity the specific viscosity in dichloroacetic acid is first measured in a concentration of 1% by weight at 25° C. according to DIN 53728-3 in an Ubbelohde viscometer.

The determined intrinsic viscosity is then calculated from the measured specific viscosity×0.0006907+0.063096 (x indicates multiplication).

The polyalkylene terephthalates having the preferred intrinsic viscosity achieve an advantageous balance of mechanical and rheological properties in the compositions according to the invention.

The polyalkylene terephthalates may be produced by known methods (see, for example, Kunststoff-Handbuch, volume VIII, p. 695 et seq., Carl-Hanser-Verlag, Munich 1973).

Component C

As component C the thermoplastic molding compounds contain talc and/or talc-based mineral fillers as reinforcers or a mixture of the abovementioned reinforcers and at least one further non-talc-based reinforcer.

The further reinforcer is selected from the group consisting of mica, silicate, quartz, titanium dioxide, kaolin, amorphous silicas, magnesium carbonate, chalk, feldspar, barium sulfate, glass spheres, ceramic spheres, wollastonite and glass fibers.

In a preferred embodiment talc or a talc-based mineral filler is the sole reinforcer.

Suitable as talc-based mineral fillers in the context of the invention are any particulate fillers that the person skilled in the art associates with talc or talcum. Also suitable are all particulate fillers that are commercially available and whose product descriptions contain as characterizing features the terms talc or talcum.

Preference is given to mineral fillers having a content of talc according to DIN 55920 of more than 50% by weight, preferably more than 80% by weight, particularly preferably more than 95% by weight and especially preferably more than 98% by weight based on the total mass of filler.

Talc is to be understood as meaning a naturally occurring or synthetically produced talc.

Pure talc has the chemical composition 3 MgO.4 SiO₂.H₂O and thus has an MgO content of 31.9% by weight, an SiO₂ content of 63.4% by weight and a content of chemically bonded water of 4.8% by weight. It is a silicate having a layered structure.

Naturally occurring talc materials generally do not have the above-recited ideal composition since they are contaminated through partial replacement of the magnesium by other elements, through partial replacement of silicon by aluminum for example and/or through intergrowth with other minerals, for example dolomite, magnesite and chlorite.

Talc grades particularly preferably employed as component C feature particularly high purity, characterized by an MgO content of 28% to 35% by weight, preferably 30% to 33% by weight, especially preferably from 30.5% to 32% by weight, and an SiO₂ content of 55% to 65% by weight, preferably 58% to 64% by weight, especially preferably 60% to 62.5% by weight.

The particularly preferred talc grades further feature an Al₂O₃ content of less than 5% by weight, more preferably less than 1% by weight, especially less than 0.7% by weight.

Also advantageous and thus preferred is in particular the use of the talc according to the invention in the form of finely ground grades having an average particle size d₅₀ of 0.1 to 20 μm, preferably 0.2 to 10 μm, more preferably 0.5 to 5 μm, yet more preferably 0.7 to 2.5 μm and particularly preferably 1.0 to 2.0 μm.

The talc-based mineral fillers for use in accordance with the invention preferably have an upper particle size or grain size d₉₅ of less than 10 μm, preferably less than 7 μm, particularly preferably less than 6 μm and especially preferably less than 4.5 μm. The d₉₅ and d₅₀ values of the fillers are determined by SEDIGRAPH D 5 000 sedimentation analysis according to ISO 13317-3.

The talc-based mineral fillers may optionally have been subjected to a surface treatment to achieve better coupling to the polymer matrix. They may for example have been provided with an adhesion promoter system based on functionalized silanes.

The average aspect ratio (diameter to thickness) of the particulate fillers is preferably in the range 1 to 100, particularly preferably 2 to 25 and especially preferably 5 to 25 determined by electron micrographs of ultrathin sections of the finished products and measurement of a representative amount (about 50) of filler particles.

As a result of the processing to afford the molding compound/molded articles the particulate fillers may have a smaller d₉₅/d₅₀ in the molding compound/in the molded article than the originally employed fillers.

Component D

As component D the composition contains phosphorous acid H₃PO₃. The phosphorous acid may be used as a solid or as an aqueous solution. Use as a solid is preferred. In the compositions according to the invention this improves the stability of the polymer components used during compounding and thus improves the mechanical properties of the composition. In addition, metering into the compounding unit is easier than with an aqueous acid solution and the risk of possible corrosion of machine parts is also significantly reduced.

Component D may also be bonded to an organic or inorganic adsorber or absorber and used in this form. This is done for example by mixing the component D with the adsorber or absorber to form a free-flowing powder prior to compounding of the composition. These absorbers or adsorbers are preferably finely divided and/or porous materials having a large external and/or internal surface area.

These materials are preferably thermally inert inorganic materials such as for example oxides or mixed oxides, silicates, silica, sulfides, nitrides of metals or transition metals. In a particularly preferred embodiment these are finely divided and/or microporous silicas or silicon oxides or silicates of natural or synthetic origin.

It is also possible for the phosphorous acid to be employed in the form of a masterbatch based on polycarbonate or polyester. The term masterbatch is to be understood as meaning that the phosphorous acid is premixed with the thermoplastic (polycarbonate or polyester) in a greater quantity than the intended use concentration in the composition. This mixture is then added to the composition in an appropriate amount so that the desired acid concentration in the composition is achieved.

Component E

The composition may comprise commercially available polymer additives as component E.

Commercially available polymer additives of component E include additives such as, for example, internal and external lubricants and demolding agents (for example pentaerythritol tetrastearate, montan wax or polyethylene wax), conductivity additives (for example conductive carbon black or carbon nanotubes), UV/light protectants, stabilizers (for example heat stabilizers, nucleating agents (for example sodium phenylphosphinate, aluminum oxide, silicon dioxide, salts of aromatic carboxylic acids), antioxidants, transesterification inhibitors, hydrolysis protectants), scratch resistance-improving additives (for example silicone oils), IR absorbers, optical brighteners, fluorescent additives, and also dyes and pigments (for example titanium dioxide, ultramarine blue, iron oxide, carbon black, phthalocyanines, quinacridones, perylenes, nigrosine and anthraquinones) and fillers and reinforcers distinct from component C) or else mixtures of a plurality of the recited additives.

The compositions preferably contain no fillers and reinforcers distinct from component C.

The compositions according to the invention preferably contain at least one demolding agent, preferably pentaerythritol tetrastearate.

In a preferred embodiment the composition contains as component E at least one additive selected from the group comprising lubricants and demolding agents, UV/light protectants, stabilizers, antistats, dyes, pigments and fillers and reinforcers distinct from component C).

The additives may be employed alone or in admixture/in the form of masterbatches.

Production of the Molding Compounds and Molded Articles

The compositions according to the invention can be used to produce thermoplastic molding compounds. The thermoplastic molding compounds according to the invention may be produced for example when the respective constituents of the compositions are in familiar fashion mixed and melt-compounded and melt-extruded at temperatures of preferably 200° C. to 320° C., particularly preferably at 240° C. to 310° C., very particularly preferably at 260° C. to 300° C., in customary apparatuses such as internal kneaders, extruders and twin-screw extruders for example. In the context of the present application this process is generally referred to as compounding.

The term “molding compound” is thus to be understood as meaning the product obtained when the constituents of the composition are melt-compounded and melt-extruded.

The mixing of the individual constituents of the compositions may be carried out in a known manner, either successively or simultaneously, either at about 20° C. (room temperature) or at a higher temperature. This means, for example, that some of the constituents can be metered in via the main intake of an extruder and the remaining constituents can be fed in later in the compounding process via a side extruder.

The molding compounds according to the invention may be used to produce molded articles and semifinished products of any kind. These may be produced by injection molding, extrusion and blow-molding processes for example. A further form of processing is the production of molded articles by thermoforming from previously produced sheets or films. The molding compounds according to the invention are particularly suitable for processing by extrusion, blow-molding and deep drawing methods.

Examples of semifinished products include sheets.

The constituents of the compositions may also be metered directly into an injection molding machine or into an extrusion apparatus and processed into molded articles.

Examples of such molded articles that are producible from the compositions and molding compounds according to the invention are films, profiles, housing parts of any kind, for office machines such as monitors, flatscreens, notebooks, printers, copiers; sheets, pipes, electrical installation ducts, windows, doors and other profiles for the construction sector and also electrical and electronic components such as switches, plugs and sockets, and parts for vehicles, in particular for the automotive sector. The compositions and molding compounds according to the invention are also suitable for producing the following molded articles or moldings: interior fitting components for rail vehicles, ships, aircraft, buses and other motor vehicles, bodywork parts for motor vehicles, housings for electrical appliances containing small-scale transformers, housings for information processing and transmission devices, housings and lining for medical appliances, massage appliances and housings therefor, children's toy vehicles, flat wall elements, housings for safety devices, thermally insulated transport containers, moldings for sanitary and bathroom equipment, cover grilles for blower vents and housings for garden appliances.

The present invention further relates to molded articles produced from the abovementioned compositions, preferably sheetlike moldings such as sheets and vehicle body parts such as mirror housings, fenders, spoilers, hoods etc.

The molded articles may be small or large and employed for exterior or interior applications. It is preferable to produce large moldings for vehicle construction, especially the automotive sector. The molding compounds according to the invention may especially be used for fabricating vehicle body exterior parts, for example fenders, trunk lids, engine hoods, bumpers, load beds, covers for load beds, vehicle roofs or other vehicle body accessory parts.

Molded articles/semifinished products made of the molding compounds/compositions according to the invention may also be disposed in composites with further materials, for example metal or plastic. After any painting of for example vehicle body exterior parts, paint layers may be disposed directly on the molding compounds according to the invention and/or on the materials used in the composite. The molding compounds according to the invention and the moldings/semifinished products made of the molding compounds according to the invention may be used for producing finished parts such as for example vehicle body exterior parts in composites with other materials or themselves through customary techniques of bonding and joining several components or parts such as for example coextrusion, film insert molding, overmolding of inserts, adhesive bonding, welding, screwing or clamping.

The compositions according to the invention feature exceptional heat resistance and stability. The compositions according to the invention additionally have a low CLTE in conjunction with good impact strength, a high modulus of elasticity, good flowability, high heat resistance and reduced shrinkage in thermoplastic processing.

Further embodiments 1 to 38 of the present invention are described hereinbelow:

1. Composition for producing a thermoplastic molding compound, wherein the composition contains or consists of the following constituents:

A) 50% to 70% by weight of at least one aromatic polycarbonate,

B) 16% to 40% by weight of at least one polyalkylene terephthalate,

C) 8% to 22% by weight of at least one talc-based mineral filler,

D) 0.0110% to 0.0280% by weight of phosphorous acid

E) 0% to 8.0% by weight of at least one additive.

2. Composition according to embodiment 1, characterized in that the component A has a weight-average molecular weight Mw, determined by gel permeation chromatography in methylene chloride using polycarbonate based on bisphenol A as a standard, of 20 to 40 kg/mol.

3. Composition according to either of the preceding embodiments, characterized in that the component A has a weight-average molecular weight Mw, determined by gel permeation chromatography in methylene chloride using polycarbonate based on bisphenol A as a standard, of 20 to 32 kg/mol.

4. Composition according to any of the preceding embodiments, characterized in that the component A has a weight-average molecular weight Mw, determined by gel permeation chromatography in methylene chloride using polycarbonate based on bisphenol A as a standard, of 22 to 28 kg/mol.

5. Composition according to any of the preceding embodiments, characterized in that a polycarbonate based on bisphenol A is used as component A.

6. Composition according to any of the preceding embodiments, characterized in that the component B contains structural units derived from terephthalic acid and up to 50 mol % of structural units from phthalic acid, isophthalic acid, naphthalene-2,6-dicarboxylic acid, 4,4′-diphenyldicarboxylic acid, succinic acid, adipic acid, and cyclohexanedicarboxylic acid.

7. Composition according to any of the preceding embodiments, characterized in that the component B contains no structural units of an acid other than terephthalic acid and isophthalic acid.

8. Composition according to any of the preceding embodiments, characterized in that the component B contains no structural units of an acid other than terephthalic acid.

9. Composition according to any of the preceding embodiments, characterized in that component B contains structural units derived from ethylene glycol, butane-1,4-diol, propanediol, cyclohexane-1,4-dimethanol, tetramethylcyclobutanediol and isosorbitol.

10. Composition according to any of the preceding embodiments, characterized in that component B is selected from the group consisting of polyethylene terephthalates and polybutylene terephthalates.

11. Composition according to any of the preceding embodiments, characterized in that polyethylene terephthalate is employed as component B.

12. Composition according to any of the preceding embodiments, characterized in that component B has an intrinsic viscosity of 0.52 dl/g to 0.95 dl/g.

13. Composition according to any of the preceding embodiments, characterized in that component B has an intrinsic viscosity of 0.56 dl/g to 0.80 dl/g.

14. Composition according to any of the preceding embodiments, characterized in that component B has an intrinsic viscosity of 0.58 dl/g to 0.68 dl/g.

15. Composition according to any of the preceding embodiments, characterized in that a polyethylene terephthalate having an intrinsic viscosity of 0.58 dl/g to 0.68 dl/g is employed as component B.

16. Composition according to any of the preceding embodiments, characterized in that a talc having an Al2O3 content of less than 0.7% by weight is employed as component C.

17. Composition according to any of the preceding embodiments, characterized in that component C) has an upper grain size d95 of less than 6 μm.

18. Composition according to any of the preceding embodiments, characterized in that component D is employed as a solid.

19. Composition according to any of the preceding embodiments, characterized in that component D is employed bonded to an organic or inorganic adsorber or absorber.

20. Composition according to embodiment 20, characterized in that component D is employed bonded to silica.

21. Composition according to any of the preceding embodiments, characterized in that the weight ratio of component D to component B is 0.0003:1 to 0.0010:1.

22. Composition according to any of the preceding embodiments, characterized in that the weight ratio of component D to component B is 0.0004:1 to 0.0008:1.

23. Composition according to any of the preceding embodiments containing no fillers and reinforcers distinct from component C.

24. Composition according to any of the preceding embodiments, characterized in that the composition is free from rubber-modified graft polymers.

25. Composition according to any of the preceding embodiments, characterized in that the composition is free from vinyl (co)polymers.

26. Composition according to any of the preceding embodiments, characterized in that the composition is free from styrene-acrylonitrile copolymers.

27. Composition according to any of the preceding embodiments, characterized in that the composition is free from phosphorus-based flame retardants.

28. Composition according to any of the preceding embodiments, characterized in that the composition is free from carbon fibers.

29. Composition according to any of the preceding embodiments containing or consisting of

52% to 68% by weight of the component A,

18% to 30% by weight of the component B,

10% to 20% by weight of the component C,

0.0115% to 0.0250% by weight of the component D,

0.1% to 7% by weight of the component E.

30. Composition according to any of the preceding embodiments containing or consisting of

54% to 66% by weight of the component A,

20% to 26% by weight of the component B,

12% to 18% by weight of the component C,

0.0120% to 0.0220% by weight of the component D,

0.3% to 6% by weight of the component E.

31. Composition according to any of the preceding embodiments, containing 0.0120% to 0.0160% by weight of component D.

32. Composition according to any of the preceding embodiments consisting to an extent of 90% by weight of the components A to E.

33. Composition according to any of the preceding embodiments consisting to an extent of 95% by weight of the components A to E.

34. Composition according to any of the preceding embodiments, consisting of the components A to E.

35. Process for producing a molding compound, characterized in that the constituents of a composition according to any of embodiments 1 to 34 are mixed with one another at a temperature of 200° C. to 320° C. and subsequently cooled and pelletized.

36. Molding compound obtainable by a process according to embodiment 35.

37. Use of a composition according to any of embodiments 1 to 34 or of a molding compound according to embodiment 36 for producing molded articles.

38. Molded article obtainable from a composition according to any of embodiments 1 to 34 or from a molding compound according to embodiment 36.

### EXAMPLES

Component A

Linear polycarbonate based on bisphenol A having a molecular weight of 24 kg/mol (weight-average M_{w}, measured by GPC (gel permeation chromatography) using a polycarbonate standard based on bisphenol A).

Component B

Polyethylene terephthalate (for example PET from Invista, Germany) having an intrinsic viscosity of 0.623 dl/g. The specific viscosity is measured in dichloroacetic acid in a concentration of 1% by weight at 25° C. The intrinsic viscosity is calculated from the specific viscosity according to the following formula.

Intrinsic viscosity=specific viscosity×0.0006907+0.063096

Component C

Talc having an average particle diameter d₅₀ of 1.2 μm and a d₉₅ of 3.5 m measured using a sedigraph and having an Al₂O₃ content of 0.5% by weight.

Component D

Phosphorous acid H₃PO₃ as a solid

Component E-1

Black Pearls™ 800 carbon black

Component E-2

Montanic acid ester wax (Licowax™ E) as a lubricant/demolding agent

Component E-3

Pentaerythritol tetrastearate as a lubricant/demolding agent

Production of the Molding Compounds

The molding compounds according to the invention containing the components A to E are produced on a ZSK25 twin-screw extruder from Coperion, Werner and Pfleiderer (Germany) at melt temperatures of 270° C. to 290° C.

Production of the Test Specimens and Testing

The pellets obtained from the respective compounding were processed into test specimens on an injection molding machine (for example from Arburg) at a melt temperature of 270° C. and a mold temperature of 70° C.

Melt flowability is assessed by means of the melt volume flow rate (MVR) measured according to ISO 1133 (2012 version) at a temperature of 270° C. and with a die load of 5 kg.

Heat resistance was measured according to DIN ISO 306 (Vicat softening temperature, method B with 50 N load and a heating rate of 120 K/h, 2013 version) on a test specimen injection-molded from one side and having dimensions of 80×10×4 mm.

Impact strength is determined according to ISO 180/1U (1982 version) at room temperature (23° C.) or −30° C. by a 10-fold determination on test bars measuring 80 mm×10 mm×4 mm.

The examples which follow serve to further elucidate the invention.

TABLE 1

| Component | | | | | | |
|---|---|---|---|---|---|---|
| (parts by weight) | | V1 | 2 | 3 | 4 | V5 |
| A PC | | 61.4 | 61.4 | 61.4 | 61.4 | 61.4 |
| B PET | | 22.6 | 22.6 | 22.6 | 22.6 | 22.6 |
| C Talc | | 15.0 | 15.0 | 15.0 | 15.0 | 15.0 |
| D H3PO3 | | 0.0100 | 0.0125 | 0.0150 | 0.0200 | 0.0300 |
| E-1 Carbon black | | 0.45 | 0.45 | 0.45 | 0.45 | 0.45 |
| E-21 Licowax | | 0.2 | 0.2 | 0.2 | 0.2 | 0.2 |
| E-3 PETS | | 0.37 | 0.37 | 0.37 | 0.37 | 0.37 |
| Properties | Unit | | | | | |
| Vicat | °C. | 143 | 142 | 143 | 143 | 143 |
| MVR | cm³/10 min | 34 | 35 | 33 | 34 | 37 |
| Izod impact strength 23° C. | kJ/m² | 64 | 89 | 85 | 74 | 65 |
| Izod impact strength −30° C. | kJ/m² | 67 | 69 | 71 | 70 | 64 |

Table 1 shows that the compositions according to the invention allow production of molding compounds having good flowability (MVR) and molded articles having a high heat resistance (Vicat) in conjunction with improved impact strength at room temperature and at −30° C. If the concentration of component D is outside the claimed range the impact strength is insufficient. The compositions according to examples 2 and 3 for which the impact strength at 23° C. is most improved are very particularly preferred.

1. A thermoplastic molding composition comprising:
A) 50% to 70% by weight of at least one aromatic polycarbonate,
B) 16% to 40% by weight of at least one polyalkylene terephthalate,
C) 8% to 22% by weight of at least one talc-based mineral filler,
D) 0.0110% to 0.0280% by weight of phosphorous acid,
E) 0% to 8.0% by weight of at least one additive.

2. The composition of claim 1, wherein component A has a weight-average molecular weight Mw, determined by gel permeation chromatography in methylene chloride using polycarbonate based on bisphenol A as a standard, of 22 to 28 kg/mol.

3. The composition of claim 1, wherein component B is selected from the group consisting of polyethylene terephthalates and polybutylene terephthalates.

4. The composition of claim 3, wherein component B is a polyethylene terephthalate having an intrinsic viscosity of 0.58 dl/g to 0.68 dl/g is employed as component B.

5. The composition of claim 1, wherein component C is a talc having an Al₂O₃ content of less than 0.7% by weight.

6. The composition of claim 1, wherein component C has an upper grain size d₉₅ of less than 6 μm.

7. The composition of claim 1, wherein component D is solid.

8. The composition of claim 1, wherein the weight ratio of component D to component B is 0.0003:1 to 0.0010:1.

9. The composition of claim 1, wherein the composition does not comprise any fillers or reinforcers other than component C.

10. The composition of claim 1 comprising:
54% to 66% by weight of component A,
20% to 26% by weight of component B,
12% to 18% by weight of component C,
0.0120% to 0.0220% by weight of the component D,
0.3% to 6% by weight of component E.

11. The composition of claim 1 consisting of components A to E.

12. A process for producing a molding compound, wherein the constituents of the composition of claim 1 are mixed with one another at a temperature of 200° C. to 320° C. and subsequently cooled and pelletized.

13. A molding compound produced by the process of claim 12.

14. (canceled)

15. A molded article produced from the composition of claim 1.

16. A molded article produced from the molding compound of claim 13.
